(19) United States
(12) Patent Application Publication
(10) Pub. No.: US 2026/0208126 A1
(43) Pub. Date: Jul. 23, 2026

(54) ULTRAFILTRATION MEMBRANE FOR OIL/WATER SEPARATION AND METHOD OF PREPARATION THEREOF

(71) Applicant: KING FAHD UNIVERSITY OF PETROLEUM AND MINERALS, Dhahran (SA)

(72) Inventors: Salhi BILLEL, Dhahran (SA); Amir AL-AHMED, Dhahran (SA)

(73) Assignee: KING FAHD UNIVERSITY OF PETROLEUM AND MINERALS, Dhahran (SA)

(21) Appl. No.: 19/034,324

(22) Filed: Jan. 22, 2025

(51) Int. Cl. B01D 71/02; B01D 17/02; B01D 61/14; B01D 67/00; C01B 32/324; C01B 32/348; C02F 1/44; C02F 101/32

(52) U.S. Cl. CPC B01D 71/021; B01D 17/02; B01D 61/145; B01D 67/0039; B01D 71/027; C01B 32/324; C01B 32/348; C02F 1/444; C02F 2101/32

(57) ABSTRACT

An ultrafiltration membrane containing at least partially calcined particulate kaolin; coal fly ash as defined by ASTM C618-22; activated carbon having a surface area of at least 1000 meter square per gram (m²/g), as determined by Brunauer-Emmett-Teller (BET) analysis; and, a hydrophilic polymer binder. The ultrafiltration membrane is in the form of a compressed powdered solid. Particles of the at least partially calcined particulate kaolin, the coal fly ash, the activated carbon and the hydrophilic polymer binder are homogeneously dispersed within the ultrafiltration membrane.

### BACKGROUND

### Technical Field

The present disclosure is directed towards a filtration membrane, more particularly, an ultrafiltration membrane for oil/water separation.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Oil/water separation is a critical process in various industries, including petroleum, chemical, food processing and wastewater treatment. Efficient separation techniques are essential to address environmental concerns, enhance resource recovery, and comply with stringent regulatory standards. The discharge of oily wastewater poses significant environmental risks, including water pollution, harm to aquatic life, and soil contamination.

Efficient oil/water separation is crucial in preventing oil contamination in water bodies, protecting aquatic ecosystems, and maintaining water quality. Proper separation techniques also reduce the risk of soil contamination, preserving soil health and preventing land degradation. Industries are required to comply with strict environmental regulations regarding the discharge of oily wastewater. Treated water can be reused in various industrial processes, reducing water consumption, and promoting sustainable water management practices. Advanced separation technologies can thereby reduce operational costs by minimizing the need for chemical treatments and lowering energy consumption. Improved separation processes may increase the overall efficiency of industrial operations, leading to better productivity and profitability.

Conventional methods for oil/water separation—such as gravity separation, centrifugation, and chemical treatments—often face limitations in terms of efficiency, cost, and environmental impact. Membrane technology has emerged as a promising solution for oil/water separation due to its high efficiency, low energy consumption, and ability to handle complex mixtures. However, commercial membranes face challenges such as fouling, limited chemical resistance, and high production costs. Therefore, developing advanced membrane materials that overcome these limitations are of paramount importance.

The ultrafiltration and microfiltration methods of membrane separation technology are characterized on the basis of the nature of the oil/water emulsion and the size of the oil droplets in water. Various functional materials, including polymer composites, metal mesh, metal oxides, and textiles have been explored as membrane materials for separating oil/water emulsions. While these materials have shown some success in oil/water demulsification, they often prove to be chemically and mechanically unstable for long-term use. Additionally, the known materials lack the necessary flexibility, leading to a search for extremely stable, efficient, and cost-effective membrane materials. Ceramic membranes made from zirconia, titania, silica, and alumina offer superior chemical, mechanical, thermal, and biological resistance compared to other materials. These membranes can withstand a wide range of temperatures and pH levels, making them ideal for oil/water separation. To enhance separation efficiency, ceramic membranes are often modified with functional elements to improve wettability, achieving better water or oil removal capabilities. Several key studies illustrate these advancements. For example, it has been reported that ceramic membranes coated with certain transition metal oxides can exhibit excellent fouling resistance in oil-in-water emulsion treatment and further that the addition of micro-zirconia to alumina microfiltration membranes can improve hydrophilicity, fouling resistance and oil-water separation efficiency. [See: Zhou, J. E. et al., Separation of stable oil-water emulsion by the hydrophilic nano-sized ZrO₂ modified Al₂O₃ microfiltration membrane. Separation and Purification Technology, 75(3), 243-248 (2010); and, Lu, D. et al., Influence of surface properties of filtration-layer metal oxide on ceramic membrane fouling during ultrafiltration of oil/water emulsion. Environmental Science & Technology, 50(9), 4668-4674 (2016).]. Further, titania coated ceramic membranes have demonstrated improved flux, hydrophilicity and effectiveness in oil-water treatment and effective oil-water separation has been achieved using zirconia-based ceramics onto which hexadecyltrimethoxysilane has been grafted: the so-modified membrane, with its hydrophobic and oleophilic properties, demonstrated high oil flux, water rejection, and thermal and chemical stability. [See: Chang, Q. et al., Application of ceramic microfiltration membrane modified by nano-TiO2 coating in separation of a stable oil-in-water emulsion. Journal of Membrane Science, 456, 128-133 (2014); and, Gao, N. et al., Modified ceramic membranes for low fouling separation of water-in-oil emulsions. Journal of Materials Science, 51, 6379-6388 (2016).] Most of the processes by which ceramics are modified involve multiple phases and specific post-treatments to improve coating-substrate adhesion. Therefore, developing simple methods to create oil-water separation membranes with high stability, flux, and separation efficiency at low cost is crucial.

Although several ultrafiltration membranes have been developed in the past, there still exists a need to develop more efficient filtration membranes for oil-water separation with cost-effectiveness, high stability, flux, and separation efficiency. Accordingly, the present disclosure provides a membrane that contains at least partially calcined particulate kaolin, coal fly ash, activated carbon, and a hydrophilic polymer binder.

### SUMMARY

In an exemplary embodiment, an ultrafiltration membrane is described. The ultrafiltration membrane comprises: at least partially calcined particulate kaolin; coal fly ash as defined by ASTM C618-22; activated carbon having a surface area of at least 1000 meter square per gram (m²/g) as determined by Brunauer-Emmett-Teller (BET) analysis; and, a hydrophilic polymer binder. The ultrafiltration membrane is in the form of a compressed powdered solid. Particles of the at least partially calcined kaolin, the coal fly ash, the activated carbon and the hydrophilic polymer binder are homogeneously dispersed in the ultrafiltration membrane.

In some embodiments, the ultrafiltration membrane comprises, based on the total weight of the membrane: from about 30 to about 50 weight percent (wt. %) of the at least partially calcined particulate kaolin; from about 30 to about 50 wt. % of the coal fly ash; from about 1 to about 20 wt. % of the activated carbon and, from about 5 to about 20 wt. % of the hydrophilic polymer binder.

In some embodiments, the ultrafiltration membrane comprises, based on the total weight of the membrane: from about 35 to about 45 wt. % of the at least partially calcined particulate kaolin; from about 35 to about 45 wt. % of the coal fly ash; from about 5 to about 15 wt. % of the activated carbon; and, from about 10 to about 15 wt. % of the hydrophilic polymer binder.

In some embodiments, the activated carbon has a surface area of from about 1200 to about 2400 m²/g, as determined by Brunauer-Emmett-Teller (BET) analysis.

In some embodiments, the activated carbon has a surface area of from about 1300 to about 1900 m²/g, as determined by Brunauer-Emmett-Teller (BET) analysis.

In another exemplary embodiment, a method of making activated carbon is described. The method comprises: dry-comminuting waste cellulose acetate fibers; subjecting the comminuted cellulose acetate to hydrothermal carbonization at a temperature of from about 150 to about 350 degrees Celsius (° C.); drying the carbonized product; activating the dried carbonized product by heating the product under an inert atmosphere with a solid-state alkali comprising potassium hydroxide, potassium carbonate or mixtures thereof, and, cooling and neutralizing the activated product.

In some embodiments, at least a fraction of the waste cellulose acetate fibers is obtained from used cigarette filters.

In some embodiments, the hydrophilic polymer binder includes polyvinylpyrrolidone (PVP).

In some embodiments, the ultrafiltration membrane has a flux of at least about 500 lumens per square meter per hour (Lm⁻²h⁻¹) as determined at about 200 kilopascals (kPa) and about 25° C. in accordance with ASTM D5090-20.

In some embodiments, the ultrafiltration membrane has a flux of from about 600 to about 800 Lm⁻²h⁻¹ as determined at about 200 kPa and about 25° C. in accordance with ASTM D5090-20.

In another exemplary embodiment, a method of preparing the ultrafiltration membrane is described. The method comprises: admixing particulate kaolin, the fly ash, the activated carbon and the hydrophilic polymer binder; compression molding the admixture; isothermally heating the compression molded admixture at a temperature in the range of from about 500 to about 1000° C. for a duration of from about 1 to about 5 hours (h); and, cooling the obtained product.

In some embodiments, the compression molded admixture is isothermally heated at a temperature in the range of from about 800 to about 1000° C. for a duration of from about 2 to about 5 hours. Where the hydrophilic polymer of the compression molded admixture may degrade in an oxidative environment at the temperature of isothermal heating, this heating may be performed in oxygen-limited environment or in an inert atmosphere.

In another exemplary embodiment, a method of making the admixed activated carbon is described. The method comprises: dry-comminuting waste cellulose acetate fibers; subjecting the comminuted cellulose acetate to hydrothermal carbonization at a temperature of from about 150 to about 350° C.; drying the carbonized product; activating the dried carbonized product by heating the product under an inert atmosphere with a solid-state alkali comprising potassium hydroxide, potassium carbonate or mixtures thereof; and, cooling and neutralizing the activated product.

In some embodiments, at least a fraction of the waste cellulose acetate fibers is obtained from used cigarette filters.

In some embodiments, the hydrothermal carbonization comprises: admixing the comminuted cellulose acetate with water at a ratio by weight of cellulose acetate:water of from about 1:5 to about 1:20; and, heating the obtained mixture in a closed vessel at a temperature of from about 150 to about 350° C. for a duration of from about 1 to about 5 hours.

In some embodiments, the obtained mixture is heated in a closed vessel at a temperature of from about 150 to about 250° C. for a duration of from about 2 to about 5 hours.

In some embodiments, a method of activating the dried carbonized product is described. The method comprises: admixing the dried carbonized product with the solid-state alkali; and, isothermally heating the obtained admixture at a temperature in the range of from about 600 to about 900° C. for a duration of from about 1 to about 3 hours.

In some embodiments, the dried carbonized product and the solid-state alkali are admixed at a ratio by weight of from about 1:2 to about 1:5.

In some embodiments, the activated product is neutralized by rinsing the product with an aqueous hydrochloride (HCl) solution and subsequently with deionized water.

In yet another exemplary embodiment, an ultrafiltration method is described. The method comprises flowing an aqueous dispersion through the ultrafiltration membrane and collecting the permeate.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a method flow chart for preparing an activated carbon, according to certain embodiments.

FIG. 1B is a method flow chart for preparing an ultrafiltration membrane, according to certain embodiments.

FIG. 1C is a flow chart of an ultrafiltration method, according to certain embodiments.

FIG. 2 is an illustration of exemplary steps for the preparation of a kaolin/fly ash/activated carbon ultrafiltration membrane, according to certain embodiments.

FIG. 3 shows a Fourier transform infrared (FTIR) spectra of a kaolin, a fly ash sample, a kaolin-fly ash mixture, and a kaolin-fly ash-activated carbon mixture, according to certain embodiments.

FIG. 4A shows a scanning electron microscopy (SEM) image of top view and cross section of a kaolin/fly ash membrane, according to certain embodiments.

FIG. 4B shows a scanning electron microscopy (SEM) image of top view and cross section of kaolin/fly ash/activated carbon membrane, according to certain embodiments.

FIG. 5A is a bar graph showing the permeate flux of prepared membranes at a pressure of 2 bar, according to certain embodiments.

FIG. 5B is a bar graph showing the oil rejection of prepared membranes at a pressure of 2 bar, according to certain embodiments.

FIG. 5C is a bar graph showing the variation of flux obtained using a kaolin/fly ash/activated carbon membrane at different pressures, according to certain embodiments.

FIG. 5D shows a Brunauer-Emmett-Teller (BET) nitrogen (N₂) adsorption-desorption isotherm of a kaolin/fly ash/activated carbon membrane, according to certain embodiments.

FIG. 6 shows real time photographs of different feeds flowed through an exemplary ultrafiltration membrane and of the permeate solutions obtained at different filtration pressures, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all, embodiments of the disclosure are shown.

As used herein, the words ‘a,’ ‘an’ and the like generally carry a meaning of ‘one or more,’ unless stated otherwise.

Furthermore, the terms ‘approximately,’ ‘approximate,’ ‘about,’ and similar terms generally refer to ranges that include the identified value within a margin of 20%, 10%, or preferably 5%, and any values therebetween.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The term ‘fraction’ as used herein refers to a numerical quantity which defines a part up to but not including 100 percent or the entirety of the thing in question. The term “at least a fraction” is used to denote an amount up to and including 100 percent or the entirety of the thing in question.

As used herein, number average molecular weight (Mn) and weight average molecular weight (Mw) are determined by gel permeation chromatography (GPC) with tetrahydrofuran (THF) as the eluent in accordance with DIN 55672-1:2007-08. The term polydispersity (PD) is derived from Mw and Mn and is calculated as (Mw/Mn).

As used herein, the term ‘compound’ refers to a chemical entity, regardless of its phase-solid, liquid, or gaseous—as well as its state—crude mixture, purified, or isolated.

As used herein, the term ‘particle’ refers to a small object that acts as a whole unit with regard to its transport and properties.

As used herein, the term ‘nanoparticles (NPs)’ refers to particles having a particle size of 1 nanometer (nm) to 500 nm within the scope of the present invention.

It is envisaged that particles having utility herein may be fibrous, acicular, spherical, ellipsoidal, cylindrical, bead-like, cubic or platelet-like may be present alone or in combination.

Moreover, it is envisaged that agglomerates of particles having the same or different morphologies may be present in the activated carbon.

Unless otherwise stated, the term “particle size” refers to the largest axis of the particle. In the case of a generally spherical particle, the largest axis is the diameter.

The term “median volume particle size” (Dv50), as used herein, refers to a particle size corresponding to 50% of the volume of the sampled particles being greater than and 50% of the volume of the sampled particles being smaller than the recited Dv50 value. Particle size is determined herein by Scanning Electron Microscopy (SEM).

As used herein, the Brunauer-Emmett-Teller (BET) analysis references the method of measuring the specific surface area (m²/g) of a solid material via the adsorption of gas molecules onto the surface of the solid, as detailed in standard NF ISO 5794-1, Appendix E (June 2010).

As used herein, the Barrett, Joyner, and Halenda (BJH) desorption analysis refers to the method of determining the volume of mesopores per unit mass (mL/g) of a solid material utilizing the adsorption and desorption isotherms associated with gas molecules inside the mesopores of the solid, as detailed in Technical Standard DIN 66134: 1998-02.

As used herein, the term ‘room temperature’ refers to a temperature range of ‘25 degrees Celsius (° C.)±3° C. in the present disclosure.

As used herein, the term ‘calcination’ refers to heating a compound to a high temperature, under a restricted supply of ambient oxygen. This is performed to remove impurities or volatile substances and to incur thermal decomposition.

As used herein, the term ‘activated carbon’ references a carbonaceous adsorbent having a developed internal pore structure. While activated carbon generally is formed from amorphous (non-graphitic) carbon, activated carbon may also be formed from non-amorphous carbon, such as carbon nanotubes.

As used herein, ‘carbonization’ describes a process of taking a carbonaceous precursor material and heating it to an elevated temperature and for an effective amount of time to sufficiently carbonize the material, thereby producing a carbonized body which has an elevated level of elemental carbon as compared to the precursor. During carbonization, the organic compound undergoes pyrolysis in an inert atmosphere, where volatile components are driven off, leaving behind carbon-rich material. The carbonizing atmosphere should not typically contain oxygen, as said oxygen will react with carbon and remove material from the carbonized body.

The term ‘hydrothermal carbonization’ as used herein refers to a carbonization method which utilizes H₂O as a heat transfer medium.

As used herein, ‘activation’ references a process in which a carbonized precursor is treated with an agent—conventionally an oxidizing agent—to permit the development of a desired pore structure in the activated carbonized body. During activation, some of the carbon can be reacted with the oxidizing agent to form pores of various sizes in the activated carbon.

The term ‘isothermal’ is used herein to qualify the performance of a stated action—such as a heating step or a cooling step of a process—at a substantially constant temperature.

The term “binder” is to be understood as any component having the property of introducing cohesion to the composition in which it is incorporated and which makes it possible to provide mechanical characteristics to the said formulation, such as but not limited to compressive strength, tensile strength and adherence.

As used herein, the term ‘membrane’ as used herein refers to a porous structure that is capable of separating components of a homogeneous or heterogeneous fluid. In particular, ‘pores’ in the sense of the present disclosure indicate voids allowing fluid communication between different sides of the structure. More particular in use when a homogeneous or heterogeneous fluid is passed through the membrane, some components of the fluid can pass through the pores of the membrane into a ‘permeate stream’, some components of the fluid can be retained by the membrane and can thus accumulate in a ‘retentate’ and/or some components of the fluid can be rejected by the membrane into a ‘rejection stream’. It is not precluded in the present disclosure that both the retenate and the permeate can constitute valuable materials that can be subject to further processing, if required.

Membranes can be of various thicknesses, with homogeneous or heterogeneous structures. Membranes of the present disclosure can be in the form of flat sheets or bundles of hollow fibers. Membranes can also be in various configurations, including but not limited to spiral wound, tubular, hollow fiber, and other configurations identifiable to a skilled person upon a reading of the present disclosure. The membranes of the present disclosure are neutral or uncharged, and particle transport is considered to be passive, which passive transport can be facilitated by pressure, concentration, and chemical or electrical gradients of the ultrafiltration process.

As used herein, the term ‘filtration’ refers to a mechanical or physical operation that can be employed for the separation of constituents of homogeneous or heterogeneous solutions. Types of filtration can be categorized based on the estimated sizes of chemicals to be separated and can involve particle filtration (>10 micrometer (μm)); microfiltration (0.1-10 μm); ultrafiltration (0.01-0.1 μm); nanofiltration (NF) (0.001-0.01 μm); and reverse osmosis, or RO (<0.001 μm).

As used herein, the term ‘permeate’ refers to a filtered liquid that passes through a membrane during a filtration process, leaving behind larger particles or contaminants.

The term ‘shear rate’ as used herein, references the rate of increase in the velocity of a fluid flowing in the x direction per unit distance in the orthogonal y direction. The shear rate has units of reciprocal time (s⁻¹).

As used herein, the term ‘flux’ refers to a critical metric for comparing, scaling, and assessing the general performance of a membrane. It is defined as the permeate flow per unit of time and membrane surface area, commonly expressed as lumens per square meter per hour (Lm⁻²h⁻¹).

As used herein, ‘comminuting’ refers to process of reducing the average size of solid materials into smaller particles, by crushing, grinding, cutting, vibrating, or other processes. The term ‘dry-comminuting’ refers to a comminution process which is conducted in the substantial absence of water, which water may be free water, adsorbed water, or water of crystallization. Generally, dry materials have less than about 5 wt. % water, for example less than about 1 wt. % water, or less than about 0.5 wt. % of water.

As used herein, the term ‘compression molding’ refers to a manufacturing process in which heat and pressure are brought to bear on a material disposed in a mold.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

It is noted that references in the specification to “an embodiment”, “some embodiments”, “other embodiments” or the like indicate that the embodiment(s) described may include a particular feature, structure, or characteristic, but every embodiment may not necessarily include that particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments, whether or not explicitly described, unless clearly stated to the contrary. That is, the various individual elements described below, even if not explicitly shown in a particular combination, are nevertheless contemplated as being combinable or arrangeable with each other to form other additional embodiments or to complement the described embodiment(s).

Aspects of the present disclosure are directed to a composite ultrafiltration membrane utilizing waste materials, specifically, kaolin, fly ash, and activated carbon derived from used cigarette filters. By integrating waste materials with distinct properties, the present disclosure aims to create a high-performance, cost-effective, and environmentally friendly membrane suitable for oil/water separation. The ultrafiltration membrane is also suitable for other separation applications such as, dye removal, heavy metal removal, etc.

An ultrafiltration membrane is described. The ultrafiltration membrane includes at least partially calcined particulate kaolin, coal fly ash as defined by ASTM C618-22, activated carbon, and a hydrophilic polymer binder. The ultrafiltration membrane is in the form of a compressed powdered solid. Particles of the at least partially calcined kaolin, the coal fly ash, the activated carbon and the hydrophilic polymer binder are homogeneously dispersed in the ultrafiltration membrane.

In the first aspect, the ultrafiltration membrane includes at least partially calcined particulate kaolin. Kaolin is a soft earth aluminosilicate clay—more particularly a dioctahedral phyllosilicate clay—having the chemical formula Al₂Si₂O₅(OH)₄. Kaolin is a naturally occurring layered silicate mineral with alternating octahedron and tetrahedron sheets of alumina octahedron linked by oxygen atoms from hydroxyl groups. Kaolin includes approximately 50 wt. % alumina, 50 wt. % silica, and trace impurities. Particulate kaolin is in the form of small particles or powder, which can be incorporated into the membrane structure. In alternate embodiments, other clay materials that may be used include, but are not limited to, attapulgite, bentonite, diatomaceous earth, and/or combinations thereof.

The calcination of the kaolin is carried out by heating it to a high temperature, under a restricted supply of ambient oxygen. This is performed to remove impurities or volatile substances and to induce thermal decomposition. Typically, the calcination is carried out in a furnace which is equipped with a temperature control system and which may provide a heating rate of up to about 50 degrees Celsius per minute (° C./min), for instance up to about 40° C./min, up to about 30° C./min, up to about 20° C./min, up to about 10° C./min, up to about 5° C./min, up to about 2° C./min, or up to about 1° C./min. Partial calcination of particulate kaolin transforms its hydrated aluminosilicate structure into a more crystalline form of alumina and silica, improving the porosity, surface area and stability thereof.

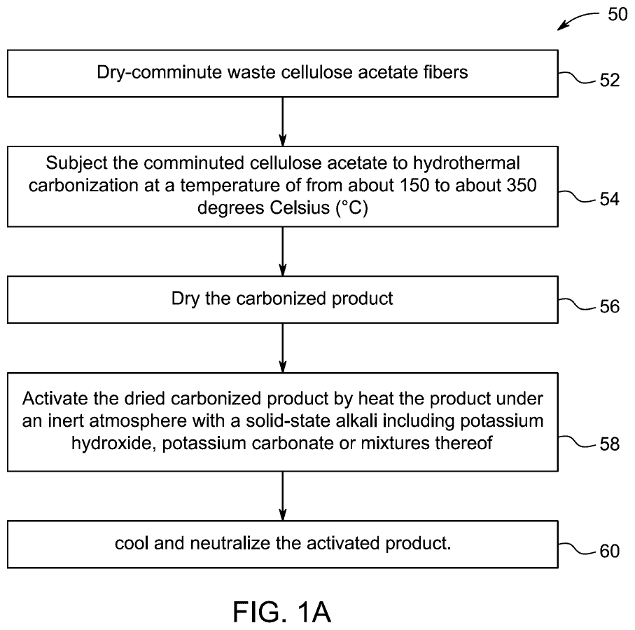

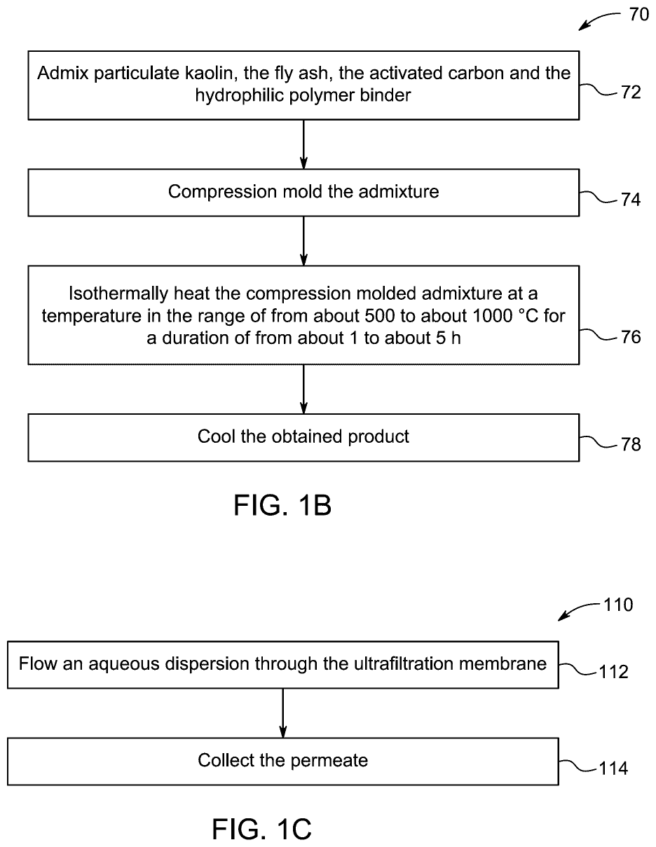

It is noted that calcination of the kaolin may be effected during the preparation of the ultrafiltration membrane, in particular during step 76 as described with respect to FIG. 1B herein below.

The ultrafiltration membrane further comprises coal fly ash as defined by ASTM C618-22. Coal fly ash is a solid particulate by-product of coal combustion that can be removed from the flue gas stream by cyclonic separation, electrostatic precipitation or bag house filtration. Coal fly ash may contain environmental contaminants, such as arsenic, beryllium, boron, cadmium, chromium VI, cobalt, lead, manganese, mercury, molybdenum, selenium, strontium, thallium, vanadium, among other contaminants.

The ultrafiltration membrane still further comprises activated carbon. Activated carbon is a highly porous material which exists in the form of loose powder, particles, or irregular agglomerates. Activated carbon is carbon produced from carbonaceous precursor materials, such as bamboo, coconut husk, willow peat, wood, coir, lignite, coal, and petroleum pitch. The activated carbon should typically have a surface area of at least 1000 meter square per gram (m²/g), for instance at least about 1100 m²/g, at least about 1200 m²/g, at least about 1300 m²/g, at least about 1400 m²/g, at least about 1500 m²/g, at least about 1600 m²/g, at least about 1700 m²/g, at least about 1800 m²/g, at least about 1900 m²/g, or at least about 2000 m²/g as determined by Brunauer-Emmett-Teller (BET) analysis.

In some embodiments, the activated carbon has a surface area of from about 1200 to about 2400 m²/g, for example from about 1300 to about 2300 m²/g, from about 1400 to about 2200 m²/g, from about 1500 to about 2100 m²/g, from about 1600 to about 2000 m²/g, from about 1700 to about 1900 m²/g, or about 1800 m²/g. In some embodiments, the activated carbon has a surface area of from about 1300 to about 1900 m²/g, for example from about 1400 to about 1800 m²/g, from about 1500 to about 1700 m²/g, or about 1600 m²/g.

The ultrafiltration membrane still further comprises a hydrophilic polymer binder. The polymer binder is used to bind or hold together different components in a composite. A hydrophilic polymer binder is a type of binder that absorbs water and forms a gel-like structure. Exemplary hydrophilic polymer binders, which may be used alone or in combination include: carboxyl vinyl polymers; polyvinylpyrrolidone (PVP); polycarboxylates; polyvinyl alcohol (PVA); cellulose; cellulose derivatives; non-cellulosic polysaccharides, such as arabinogalactans, alginate, pullulan, chitin, chitosan, guar gum, gum tragacanth, gum arabic, agar, carrageenan, xanthan gum, gellan, welan gum, rhamsan gum, curdlan gum, scleroglucan gum and tamarind gum; styrene-butadiene rubber; poly (3,4-ethylenedioxythiophene); and, polystyrene sulfonate.

The term “cellulose derivative” references a cellulose of which the constituent hydroxy groups have been reacted with a suitable reagent. For instance, at least a fraction of the hydroxyl groups may have been acylated, esterified, etherified or grafted to. Exemplary cellulose esters having utility herein, alone or in combination, include: cellulose acetate; cellulose butyrate; cellulose propionate; cellulose nitrate; cellulose sulfate; cellulose phosphate; cellulose acetate propionate; cellulose acetate butyrate; and, cellulose acetate phthalate. Exemplary cellulose ethers, having utility herein, alone or in combination include: carboxymethylcellulose; methylcellulose; ethylcellulose; hydroxyethylcellulose; hydroxypropylcellulose; hydroxybutylcellulose; and, ethoxymethylcellulose. Further exemplary cellulose derivatives, having utility herein alone or in combination, include celluloses grafted with styrene, (meth)acrylic acid, (meth)acrylate, ε-caprolactone, lactide and glycolide. It is noted, for completeness, that combinations of distinct cellulose derivatives—such as combinations of cellulose ethers and cellulose ester—may have utility in the present disclosure.

For completeness, the term polycarboxylate polymer includes the salts thereof, of which alkali metal salts may be mentioned as being exemplary. Exemplary polycarboxylate polymers may be selected from the group consisting of: poly(meth)acrylates; polymaleates; polyaspartates; polylactates; polyitaconates; copolymers of the aforementioned polymers; and, mixtures thereof.

In a preferred embodiment of the ultrafiltration membrane, the hydrophilic polymer binder comprises PVP. More particularly, the hydrophilic polymer binder comprises or consists of polyvinylpyrollidone (PVP) having a weight average molecular weight (Mw) of from about 25 to about 200 kDa (kilodaltons), for example from about 25 to about 100 kDa, from about 25 to about 75 kDa or from about 30 to about 60 kDa. In some embodiments, the ultrafiltration membrane comprises, based on the total weight of the membrane: from about 30 to about 50 wt. % of the at least partially calcined particulate kaolin; from about 30 to 50 wt. % of the coal fly ash; from about 1 to about 20 wt. % of the activated carbon; and, from about 5 to about 20 wt. % of the hydrophilic polymer binder.

In other embodiments, the ultrafiltration membrane comprises, based on the total weight of the membrane: from about 35 to about 50 wt. %, for example from about 35 to about 45 wt. % of from about 40 to 45 wt. % of the at least partially calcined particulate kaolin; from about from about 35 to about 50 wt. %, for example from about 35 to about 45 wt. % of from about 40 to 45 wt. % of the coal fly ash; from about 5 to about 20 wt. %, for example from about 5 to about 15 wt. %, or from about 10 to about 15 wt. % of the activated carbon; and, from about 5 to about 15 wt. %, for example from about 8 to about 15 wt. % or about 10 to about 15 wt. % of the hydrophilic polymer binder.

In some embodiments, the ultrafiltration membrane comprises, based on the total weight of the membrane: from about 35 to about 45 wt. % of the at least partially calcined particulate kaolin; from about 35 to about 45 wt. % of the coal fly ash; from about 5 to about 15 wt. % of the activated carbon; and, from about 10 to about 15 wt. % of the hydrophilic polymer binder, based on the total weight of the membrane.

FIG. 1A illustrates a flow chart of a method 50 for making activated carbon for inclusion in the ultrafiltration membrane. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes dry-comminuting waste cellulose acetate fibers. Cellulose acetate fibers are synthetic fibers manufactured from cellulose, a natural polymer derived mostly from wood pulp or cotton linters. Examples of cellulose acetate products which may provide a source for the cellulose acetate to be comminuted include, but are not limited to: acetate fabric; cigarette filters; eyeglass frames; photographic films; textile fibers; plastic packaging; nail polish; medical membranes; and, coatings. In important embodiments, at least a fraction of the waste cellulose acetate fibers is obtained from used cigarette filters.

At step 54, the method 50 includes subjecting the comminuted cellulose acetate to hydrothermal carbonization at a temperature of from about 150 to about 350° C., for example from about 160 to about 340° C., from about 170 to about 330° C., from about 180 to about 320° C., from about 190 to about 310° C., from about 200 to about 300° C., from about 210 to about 290° C., from about 220 to about 280° C., from about 230 to about 270° C., or from about 240 to about 260° C. In an exemplary embodiment, the method 50 includes subjecting the comminuted cellulose acetate to hydrothermal carbonization at a temperature of about 200° C.

The hydrothermal carbonization comprises the admixing of the comminuted cellulose acetate with water prior to or during the heating thereof. In certain embodiments, the ratio by weight of cellulose acetate:water is from about 1:5 to about 1:20, for example from 1:5 to about 1:15 or from about 1:8 to about 1:12. In order to preserve H₂O as the heat transfer medium, the hydrothermal carbonization should desirably be conducted in a closed vessel at the afore-described temperature.

Exemplary durations for the hydrothermal carbonization are from about 0.5 to about 5 about 5 hours, such as from about 1 to about 5 hours or from about 2 to about 4 hours.

At step 56, the method 50 includes drying the carbonized product of step 54. Exemplary drying devices include but are not limited to heating appliances such as hot plates, heating mantles ovens, microwaves, autoclaves, tapes, oil baths, salt baths, sand baths, air baths, hot-tube furnaces, and hot-air guns. The dried carbonized product may, in certain circumstances, be characterized by comprising less than about 5 wt. % of water, based on the weight of the product. For example, the dried carbonized product may comprise less than about 2 wt. %, less than about 1 wt. %, less than about 0.5 wt. % or less than about 0.1 wt. % of water, based on the weight of the product.

At step 58, the method 50 includes activating the dried carbonized product by heating the product under an inert atmosphere with a solid-state alkali comprising potassium hydroxide (KOH), potassium carbonate (K₂CO₃) or mixtures thereof. A solid-state alkali is an alkali compound that is in a solid form at room temperature rather than liquid or dissolved. It is not precluded that the solid-state alkali may comprise further basic solid compounds. It is however, preferred that the solid-state alkali consists of potassium hydroxide, potassium carbonate or mixtures thereof.

The solid state alkali is admixed with the dried carbonized product. Typically, the solid state alkali should be provided in a weight excess to the dried carbonized product. For example, the ratio by weight of solid state alkali to dried, carbonized product may be from about 2:1 to about 5:1 or from 2:1 to about 4:1.

In some embodiments, the inert atmosphere of method step 58 can be provided by nitrogen, helium, or argon. The heating may be effected by using heating appliances such as hot plates, heating mantles, hot air ovens, microwaves, autoclaves, tapes, oil baths, salt baths, sand baths, air baths, hot-tube furnaces, and hot-air guns.

The method step 58 preferably comprises isothermally heating the obtained admixture: at a temperature in the range of from about 500 to about 1000° C.; and, for a duration of from about 0.5 to about 4 hours. For example, method step 58 may comprise isothermally heating the obtained admixture: at a temperature in the range of from about 500 to about 900° C., preferably from about 600 to about 800° C.; and, for a duration of about 0.5 to about 3 hours, preferably from about 0.5 to about 2 hours.

At step 60 of FIG. 1A, the method 50 includes cooling and neutralizing the activated product. The activated product is desirably cooled to room temperature. During the neutralization step, an aqueous acid is used to neutralize the residual alkalinity from the activation process and typically to reduce the pH of the final product to the range of from about 6 to about 8, for example from about 6.8 to about 7.2, or about 7. Suitable examples of aqueous acids having utility in the neutralization step include but are not limited to, hydrochloric acid (HCl), sulfuric acid (H₂SO₄), phosphoric acid (H₃PO₄), acetic acid (CH₃COOH), hydrofluoric acid (HF) and nitric acid (HNO₃). In a preferred embodiment, the acid is HCl.

Subsequent to the neutralization step, the activated product may be rinsed with water, preferably with deionized water.

FIG. 1B illustrates a flow chart of a method 70 of preparing the kaolin/fly ash/activated carbon ultrafiltration membrane. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes admixing particulate kaolin, the fly ash, the activated carbon and the hydrophilic polymer binder. The mixing should ensure that the materials are homogeneously distributed, allowing the components to interact and bond optimally to achieve the desired product qualities.

At step 74, the method 70 includes compression molding the admixture. The method comprises compression molding the mixture by placing it in a mold, then applying heat and pressure to shape it. This helps the material take the desired shape and harden properly.

At step 76, the method 70 includes isothermally heating the compression molded admixture: at a temperature in the range of from about 500 to about-1000° C.; and, for a duration of from about 1 to about 5 hours (h). In preferred embodiments, step 76 comprises isothermally heating the compression molded admixture: at a temperature in the range of from about 600 to about 1000° C., preferably about 700 to about 1000° C., more preferably from about 800 to about 1000° C.; and, for a duration of from about 2 to about 5 hours (h), preferably from about 3 to 5 hours, and more preferably from about 3.5 to about 5 hours. In an exemplary embodiment, the compression molded admixture is isothermally heated: at a temperature in the range of from about 850 to about 950° C.; and, for a duration of from about 3 to about 5 hours. In a particularly preferred embodiment, the compression molded admixture is isothermally heated at a temperature of 900° C. for 4 hours. Where the hydrophilic polymer of the compression molded admixture may degrade in an oxidative environment at the temperature of the isothermal heating, such heating may be performed in an oxygen-limited atmosphere or under an inert atmosphere to prevent or limit such degradation.

At step 78, the method 70 includes cooling the obtained product. The product may be cooled by keeping at room temperature, placing in a cooled environment, or using controlled cooling systems such as water baths, air circulation, or refrigerated chambers to achieve the desired temperature reduction. In a preferred embodiment, the product is cooled by holding it at room temperature.

The membrane formed in step 78 is a compressed powder in which the kaolin, fly ash and activated carbon particles are homogenously dispersed with polyvinylpyrollidone (PVP). The PVP has a particulate form in the final membrane rather than forming a continuous matrix phase. The membrane further possesses a rough surface with some heterogeneity in the pores presented at the surface thereof. For instance, both elongate, crevasse-like pores may be present in the structure, together with smaller pores: those smaller pores do not have a regular or repeating morphology in that pores of both high and low roundness are interspersed. The hierarchical pore structure is considered to provide utility of the membrane in processes such as filtration or adsorption which call for interactions at several scales.

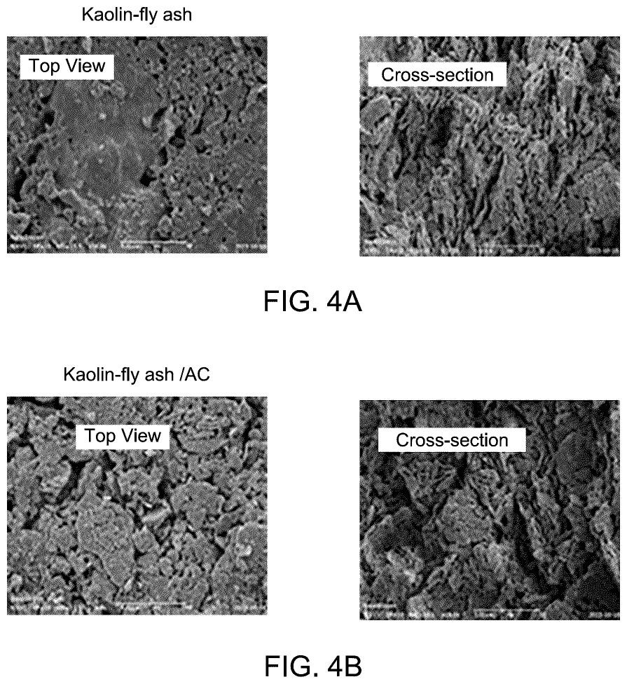

A cross-section through the membrane formed in step 78—of which FIG. 4B presents an example—indicates that the pores through the membrane present a tortuous path which, during ultrafiltration, may facilitate both physisorption of oil and mechanical entrapment of colloidal particles present in an aqueous dispersion feed stream.

FIG. 1C illustrates a flow chart of a method 110 of ultrafiltration. The order in which the method 110 is described is not intended to be construed as a limitation, and any number of the described method steps can be combined in any order to implement the method 110. Additionally, individual steps may be removed or skipped from the method 110 without departing from the spirit and scope of the present disclosure.

At step 112, the method 110 includes flowing an aqueous dispersion through the ultrafiltration membrane, such as the exemplary ultrafiltration membrane obtained in accordance with the method of FIG. 1B. The aqueous dispersion may comprise in some embodiments, dispersed in a continuous aqueous phase, solid particles, polymers, oils, heavy metals, dyes, pesticides, pharmaceutical pollutants, nanoparticles, pigments, and proteins. In a preferred embodiment, membranes were used for the oil/water (cooking oil, diesel and ether) separation. In an embodiment, the aqueous dispersion comprises an oil-in-water emulsion and, more particularly, an oil-in-water emulsion having from about 10 to about 1000 ppm by weight of oil. For example, the aqueous dispersion may be an oil-in-water emulsion comprising from about 100 to about 1000 ppm by weight of oil or from 200 to 1000 ppm by weight of oil.

At step 114, the method 110 includes collecting the permeate. This permeate typically contains water that has passed through the ultrafiltration membrane, leaving the oil and other larger particles behind. The collected permeate can then be processed or filtered according to its intended purpose, while the separated oil can be recovered for reuse or proper disposal.

The ultrafiltration membrane of the present disclosure may be used in either direct flow filtration—wherein the aqueous dispersion feed stream is forced through the membrane at a substantially perpendicular angle—or tangential flow filtration (TFF), where the aqueous dispersion feed stream flows along and tangentially to the surface of the ultrafiltration membrane.

Direct flow filtration may be preferred where the feed stream is characterized by a low concentration of particulates—such as in the ultrafiltration of an aqueous dispersion feed stream comprising or consisting of oil and water—given that there would be reduced residue build up on the surface of the membrane during filtration. Whilst direct flow filtration may be performed continuously, it is preferably performed in a batch or semi-continuous manner, permitting the membrane to be cleaned between use cycles to remove residue build-up.

As noted, however, membrane separation by tangential flow filtration is not precluded in the present disclosure. Conventionally, the retentate stream in tangential flow filtration is recycled. It is also typical for tangential flow filtration to be performed as a continuous process because a constant flow of the feed stream across the surface of the ultrafiltration membrane may prevent the accumulation of residues on the surface thereof.

Where ultrafiltration of the aqueous dispersion is conducted by tangential flow filtration, the feed of the aqueous dispersion may be represented as a laminar flow and thereby characterized by a shear rate. The shear rate of the aqueous dispersion may typically be from about 1000 to about 10000 s⁻¹, for example from about 2000 to about 10000 s⁻¹, from about 2000 to about 8000 s⁻¹ or from about 4000 to about 8000 s⁻¹.

Independently of the use of direct flow or tangential flow filtration, the method of ultrafiltration of the present disclosure may be performed at a transmembrane pressure differential, specifically a pressure difference between the retentate and permeate side of the membrane. Whilst the tolerance limit of the membrane may be a determinative of the operable transmembrane pressure differential, it is conventional herein to apply a transmembrane pressure differential of from about 50 to about 500 kPa. Exemplary transmembrane pressure differentials of from about 50 to about 400 kPa, about 50 to about 300 kPa or about 100 to about 300 kPa may be mentioned.

The transmembrane pressure differential may be controlled by inter alia: pressurizing the aqueous dispersion feed with a gas; adjusting the column height of the aqueous dispersion above the ultrafiltration membrane; through the use of pumps to adjust the flow rate of the fluids on the retentate side of the ultrafiltration membrane; through controlling drainage on the permeate side of the ultrafiltration membrane; and/or, through the use of suction applied to the permeate side of the ultrafiltration membrane.

The transmembrane pressure differential may be maintained at a constant value within the aforementioned ranges during the ultrafiltration process. In the alternative, the transmembrane pressure differential may be moderated to provide a constant permeate flow rate: typically, in this circumstance, the transmembrane pressure differential will increase during an ultrafiltration process or cycle and should, of course, be monitored to ensure that the pressure tolerance limit of the membrane is not exceeded.

In some embodiments, the ultrafiltration membrane has a flux of at least about 500 Lm⁻²h⁻¹, for example of at least about 550 Lm⁻²h⁻¹, at least about 600 Lm⁻²h⁻¹ or even at least about 650 Lm⁻²h⁻¹ as determined at about 200 kilopascals (kPa) and about 25° C. in accordance with ASTM D5090-20. In some embodiments, the ultrafiltration membrane has a flux of from about 500 to about 800 Lm⁻²h⁻¹, for example from 550 to about 750 Lm⁻²h⁻¹, from about 600 to about 700 Lm⁻²h⁻¹, or from about 625 to about 700 Lm⁻²h⁻¹, as determined at about 200 kPa and about 25° C. in accordance with ASTM D5090-20.

### EXAMPLES

The following examples demonstrate an ultrafiltration membrane for oil/water separation from an aqueous dispersion. The examples are provided solely for illustration and are not to be construed as limitations of the present disclosure, as many variations thereof are possible without departing from the spirit and scope of the present disclosure.

### Example 1: Materials

The materials used in the process include: kaolin [Al₂Si₂O₅(OH)₄, (Al₂O₃·2SiO₂·2H₂O)]; coal fly ash (Al₂O₃·SiO₂) sourced from Buchi, Nigeria; activated carbon prepared from waste cellulose acetate fibers derived from used cigarette butts; and, polyvinylpyrrolidone (PVP) from Sigma.

### Example 2: Activated Carbon Synthesis

Used cigarette butts comprising cellulose acetate fibers were collected, the wrapping paper thereof was carefully removed and the remaining fibrous material was washed with double distilled water thoroughly to remove contaminants, such as paper, tobacco particles and ash. The washed fibrous material was oven dried and the fibers was then ground into a fluffy mass using a spice grinder. Next, the ground fibers were added into a stainless-steel autoclave at a ratio of 1 gram (g) of ground solids to 10 milliliters (mL) of water. The autoclave was transferred to an oven for heating to 200 degrees Celsius (° C.), employing a temperature ramp rate of 5 degrees Celsius per minute (° C./min)). After maintaining the comminuted product at a temperature of 200° C. for 4 hours in the closed system, the hydrothermally carbonized product was allowed to cool to room temperature at a cooling rate of −5° C./min.

The resulting carbonaceous material, known as hydro-char, was recovered and dried at 100° C. For activation, a mixture of KOH and hydro-char was prepared at a ratio by weight of KOH:hydro-char of 4:1. This mixture was homogenized and placed in alumina boat and heated under nitrogen in a horizontal tube furnace. The temperature was ramped up to 600° C., 700° C., or 800° C. at a rate of 3° C./min and held at the target temperature for 1 hour. Afterward, the samples were cooled under nitrogen. The activated carbons were recovered by initial washing with 2 M hydrochloric acid (HCl) at room temperature, followed by thorough rinsing with deionized water until a neutral pH was obtained. Finally, the samples were dried in an oven at 100° C.

The activated carbons have a turbostratic, disordered structure which includes small and randomly orientated domains of graphitic carbon and further domains wherein the carbon has been imperfectly graphitized. In the latter domains, functional groups and imperfections result in a layered carbon structure having a somewhat greater interlayer gap than would be observed in well-ordered graphite.

### Example 3: Membrane Fabrication

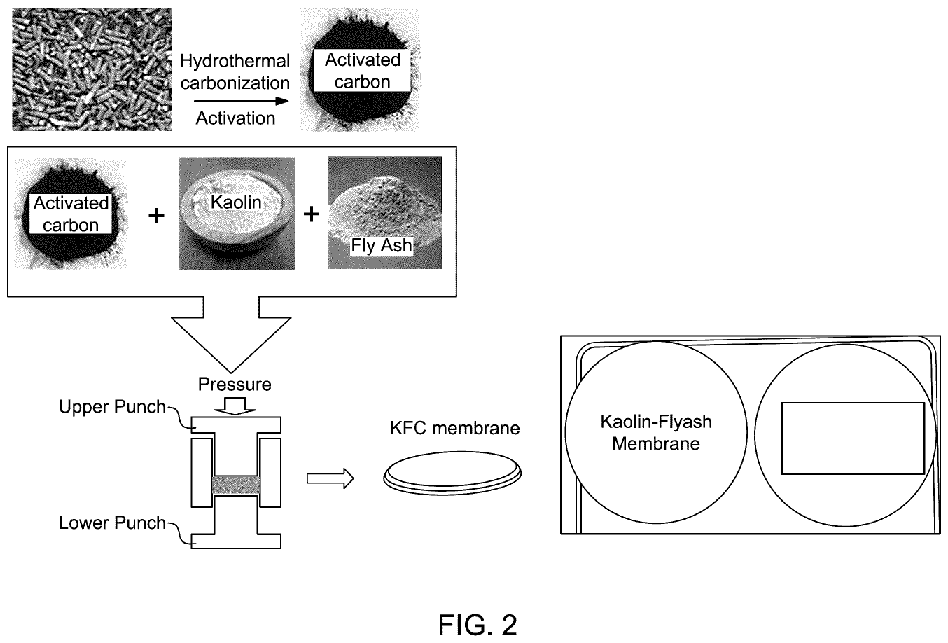

The kaolin/fly ash/activated carbon membrane was prepared by mixing 3 g of kaolin with 3 g of fly ash, lg of PVP and 700 mg of activated carbon, the activated carbon thereby constituting 10% of the total mass. A circular disk-shaped membrane was produced using a circular die and subjected to an automatic hydraulic press at 35 megapascals (MPa). After compressing, the disk-shaped membrane was heated in a furnace 900° C. (ramping temperature: 5° C./min), for 4 hours under limiting oxygen conditions to minimize the oxidative degradation of the PVP, followed by gradual cooling to room temperature at the same rate. The process of this Example has been presented schematically in FIG. 2. For comparison, reference membranes were prepared without the inclusion of the activated carbon but utilizing all other exemplified amounts and parameters.

### Example 4: Membrane Characterization

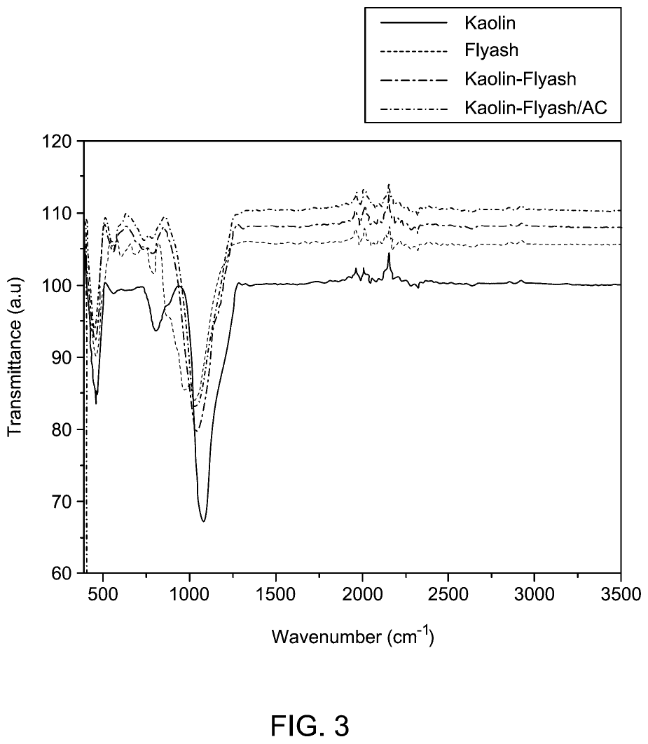

Membranes were characterized by Fourier transform infrared spectroscopy (FTIR) and field emission scanning electron microscopy (FESEM). FIG. 3 illustrates FTIR spectra for kaolin, fly ash, kaolin/fly ash, and kaolin/fly ash/activated carbon samples. This spectrum has distinctive peaks that are characteristic of the material kaolinite. Typical kaolinite peaks are often located at 3695-centimeter inverse (cm⁻¹), 3620 cm⁻¹, 1030 cm⁻¹, and 910 cm⁻¹, although the actual placements may vary. Typically, the bands are associated with hydroxyl stretching and silica-alumina vibrational modes. This spectrum appears to be a blend of characteristics from kaolin and fly ash, with certain distinctions. The presence of activated carbon may be responsible for some of the differences, particularly the expanded features between 1000 and 2000 cm⁻¹. It is known that activated carbon has a broad peak at approximately 1630 cm⁻¹ due to OH-bending from absorbed water and many peaks from functional groups on its surface.

FIG. 4A-4B shows SEM images of top view and cross section of kaolin/fly ash membrane and kaolin/fly ash/activated carbon membrane, respectively. Some heterogeneity of pore size and volume is observed for both membrane types but the reference membrane includes a larger fraction of surface area which is devoid of pores. The membrane in accordance with the present disclosure exhibits some networking by which pores disposed at the surface thereof have become conjoined; in the cross-sectional view thereof, the pores appear to present a tortuous path which may facilitate both physisorption of oil and mechanical entrapment of colloidal particles present in an aqueous dispersion feed stream.

In FIG. 4B, the channels through the membrane show some heterogeneity in diameter. The wider observed channels are those channels substantially aligned with the direction of compression applied in forming the membrane (Example 3). A comparison between FIGS. 4A and 4B appears to suggest that the incorporation of activated carbon reduces the packing density of particulates in the membrane—and concomitantly provides for wider flow paths for liquids in use—as compared to the membrane in which only fly ash and kaolin are present. Moreover, the number of flow paths for liquids observed through the cross-section of the membrane appears to be greater in the membrane containing activated carbon (FIG. 4B) than that in which activated carbon is absent (FIG. 4A).

Using a densimeter, it was found that the density of the kaolin/fly ash membrane was 2.53 g/cm³. The kaolin/fly ash/activated carbon membrane has a measured density of 1.92 g/cm³; the lower density is a consequence of the increased porosity caused by the incorporation of the activated carbon.

### Example 5: Ultrafiltration Performance

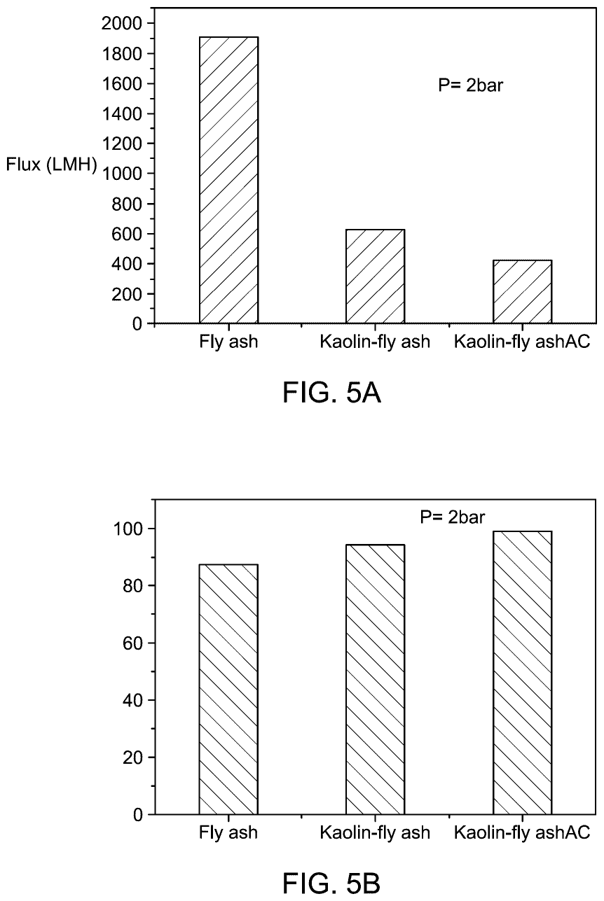

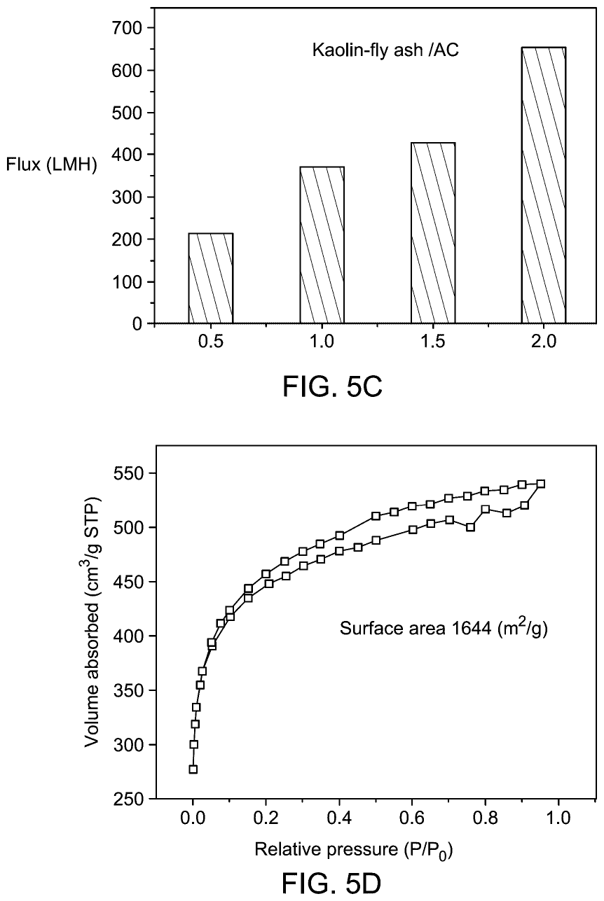

The reference and inventive membranes were used for the oil-water (cooking oil, diesel and ether) separation experiments without any further modification. For further comparison, fly ash-based disc membranes were also fabricated. FIG. 5A is a bar graph showing a permeate flux of prepared membranes at a pressure of 2 bar. FIG. 5B is a bar graph showing oil rejection of prepared membranes at a pressure of 2 bar. FIG. 5C is a bar graph showing variation of flux using kaolin/fly ash/activated carbon membrane at different pressures, according to certain embodiments. Each membrane showed very good chemical and mechanical strength. The composition of kaolin, fly ash and activated carbon, however, demonstrated improved filtering properties, with rejection of nearly 99% of undesirable components at a 2 Bar transmembrane pressure differential.

FIG. 5D shows a Brunauer-Emmett-Teller (BET) nitrogen (N₂) adsorption-desorption isotherm of the kaolin/fly ash/activated carbon membrane. Activated carbon has a large surface area (1644 meter square per gram (m²/g)) and can assist in binding within the membrane, controlling channels of the membrane and also the flux thereof.

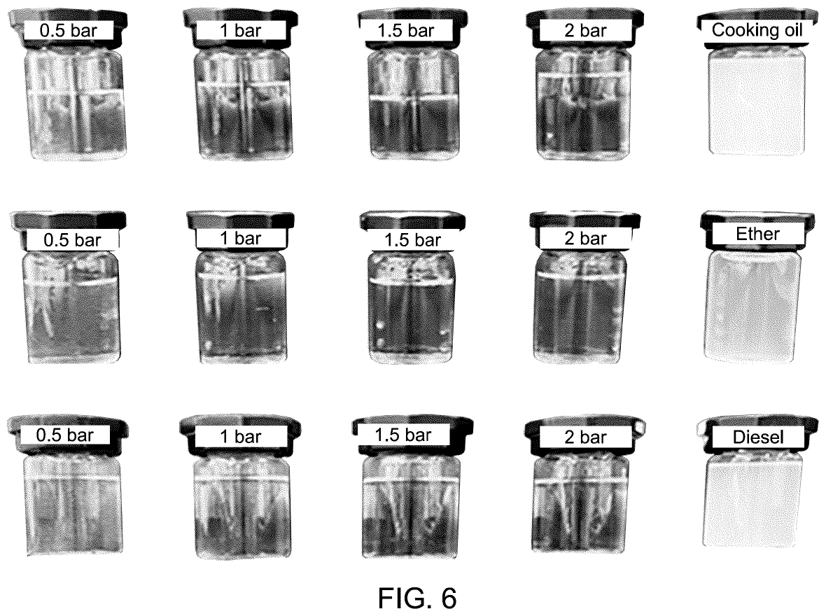

FIG. 6 shows real time photographs of: different feeds of emulsions comprising water and either cooking oil, ether or diesel; and, their permeate solutions as obtained using direct flow filtration at different applied transmembrane filtration pressures for the kaolin/fly ash/AC membranes of the present disclosure. Whilst separation of oil and water is achieved at each transmembrane pressure, greater efficacy of separation is achieved at transmembrane pressures of 100 kPa, 150 kPa and 200 KPa as compared to 50 KPa.

Table 1 herein below provides a comparison of membrane performance and cost-effectiveness of the fabricated membrane as compared to certain membranes from the literature. The permeance of the membrane of the present disclosure, as derived from the permeate flow curve slope, was 654 lumens per square meter per hour (Lm⁻²h⁻¹)/bar, which is high as compared to literature data.

TABLE 1

| Membrane base | | Separation | Flux | Pressure | |
|---|---|---|---|---|---|
| material | Modification | efficiencies | (Lm⁻²h⁻¹) | (bar) | Ref. |
| Commercial | Polyaniline | 97% | 6886 | 1.5 | A. Kayvani Fard, A. |
| Al₂O₃ | (PANI) | | | | Bukenhoudt, M. |
| | | | | | Jacobs, G. Mckay, |
| | | | | | and M. A. Atieh, |
| | | | | | “Novel hybrid |
| | | | | | ceramic/carbon |
| | | | | | membrane for oil |
| | | | | | removal,” J. Memb. |
| | | | | | Sci, vol. 559, pp. 42- |
| | | | | | 53, August 2018. [symbol] |
| Commercial | nano sized | 97.8% | 441 | 6 | B. Salhi, N. Baig, I. |
| Al₂O₃ | zirconium | | | | Abdulazeez, A. Al- |
| | dioxide | | | | Ahmed, and I. H. |
| | (ZrO₂) | | | | Aljundi, “High flux |
| | | | | | polyaniline-coated |
| | | | | | ceramic membrane |
| | | | | | for effective |
| | | | | | separation of |
| | | | | | emulsified oil-in- |
| | | | | | water,” Ceram. Int., |
| | | | | | vol. 48, no. 17, pp. |
| | | | | | 25246-25253, |
| | | | | | September 2022. [symbol] |
| Silicon carbide | Sintering | >90 | 3700 | 0.5 | J. E. Zhou, Q. Chang, |
| (SiC) | | | | | Y. Wang, J. Wang, |
| | | | | | and G. Meng, |
| | | | | | “Separation of stable |
| | | | | | oil-water emulsion by |
| | | | | | the hydrophilic nano- |
| | | | | | sized ZrO2 modified |
| | | | | | Al2O3 microfiltration |
| | | | | | membrane,” Sep. |
| | | | | | Purif. Technol., vol. |
| | | | | | 75, no. 3, pp. 243-248, |
| | | | | | November 2010. [symbol] |
| ZIF-8 | PVDF-ZnO | 92.93% | 1.11 | 0.35 | Q. Jiang et al., |
| | | | | | “Lower-temperature |
| | | | | | preparation of SiC |
| | | | | | ceramic membrane |
| | | | | | using zeolite residue |
| | | | | | as sintering aid for |
| | | | | | oil-in-water |
| | | | | | separation,” J. |
| | | | | | Memb. Sci, vol. 610, |
| | | | | | p. 118238, |
| | | | | | September 2020. [symbol] |
| Stainless steel | Polyaniline | | 1000 | 0.1 | S. Xu, L. F. Ren, Q. |
| meshes | (PANI) | | | | Zhou, H. Bai, J. Li, |
| | | | | | and J. Shao, “Facile |
| | | | | | ZIF-8 functionalized |
| | | | | | hierarchical |
| | | | | | micronanofiber |
| | | | | | membrane for high- |
| | | | | | efficiency separation |
| | | | | | of water-in-oil |
| | | | | | emulsions,” J. Appl. |
| | | | | | Polym. Sci., vol. 135, |
| | | | | | no. 27, p. 46462, |
| | | | | | July 2018. [symbol] |
| Polyvinylidene | Polyaniline | | 3000 | 0.6 | M. Liu, J. Li, and Z. |
| fluoride (PVDF) | (PANI) | | | | Guo, “Polyaniline |
| | | | | | coated membranes |
| | | | | | for effective |
| | | | | | separation of oil-in- |
| | | | | | water emulsions,” J. |
| | | | | | Colloid Interface Sci., |
| | | | | | vol. 467, pp. 261 |
| | | | | | 270, April 2016. |
| ZIF-8 | Cu(OH)₂- | 97.2% | 9 × 10⁴ | — | Q. Li et al., “High- |
| | copper mesh | | | | Flux Oil/Water |
| | | | | | Separation with |
| | | | | | Interfacial Capillary |
| | | | | | Effect in Switchable |
| | | | | | Superwetting |
| | | | | | Cu(OH)2@ZIF-8 |
| | | | | | Nanowire |
| | | | | | Membranes,” ACS |
| | | | | | Appl. Mater. |
| | | | | | Interfaces, vol. 10, |
| | | | | | no. 46, pp. 40265- |
| | | | | | 40273, November 2018. [symbol] |
| HKUST-1 | PDA@SSM | 99.99% | 300 | gravity | M. Liu, L. Tie, J. Li, |
| | | | | | Y. Hou, and Z. Guo, |
| | | | | | “Underoil |
| | | | | | superhydrophilic |
| | | | | | surfaces: water |
| | | | | | adsorption in metal- |
| | | | | | organic frameworks,” |
| | | | | | J. Mater. Chem. A |
| | | | | | Mater., vol. 6, no. 4, |
| | | | | | pp. 1692-1699, |
| | | | | | January 2018. [symbol] |
| kaolin/fly ash | Activated | 99.99% | 654 | 2 bar | This work |
| | carbon | | | | |

[symbol]

The disclosure of this reference is incorporated herein by reference in its entirety.

To conclude, kaolin/fly ash/activated carbon is a cost-effective alternative to traditional ultrafiltration membrane given that it may be prepared mostly from waste materials. The obtained membrane has moderate flux and provides high separation efficiency and robustness. This indicates that the membrane is appropriate for applications that necessitate high performance without incurring substantial expenditures. The composition of kaolin, fly ash, and activated carbon enhanced the filtering properties, effectively rejecting nearly 99% of undesirable components. By integrating waste materials with distinct properties, the invention aims to create a high-performance, cost-effective, and environmentally friendly membrane suitable for not only oil/water separation but for other separation applications such as, dye removal, heavy metal removal, etc.

Numerous modifications and variations of the present disclosure are possible in light of the above teachings. It is therefore to be understood that within the scope of the appended claims, the invention may be practiced otherwise than as specifically described herein.

1. An ultrafiltration membrane including:
at least partially calcined particulate kaolin;
coal fly ash as defined by ASTM C618-22;
activated carbon having a surface area of at least 1000 meter square per gram (m²/g) as determined by Brunauer-Emmett-Teller (BET) analysis; and,
a hydrophilic polymer binder,
wherein particles of the at least partially calcined particulate kaolin, the coal fly ash, the activated carbon and the hydrophilic polymer binder are homogeneously dispersed, and
wherein the ultrafiltration membrane is in the form of a compressed powdered solid.

2. The ultrafiltration membrane according to claim 1 including, based on the total weight of the membrane:
from about 30 to about 50 wt. % of the at least partially calcined particulate kaolin;
from about 30 to about 50 wt. % of the coal fly ash;
from about 1 to about 20 wt. % of the activated carbon; and,
from about 5 to about 20 wt. % of the hydrophilic polymer binder.

3. The ultrafiltration membrane according to claim 1 including, based on the total weight of the membrane:
from about 35 to about 45 wt. % of the at least partially calcined particulate kaolin;
from about 35 to about 45 wt. % of the coal fly ash;
from about 5 to about 15 wt. % of the activated carbon; and,
from about 10 to about 15 wt. % of the hydrophilic polymer binder.

4. The ultrafiltration membrane according to claim 1, wherein the activated carbon has a surface area of from about 1200 to about 2400 m²/g.

5. The ultrafiltration membrane according to claim 4, wherein the activated carbon has a surface area of from about 1300 to about 1900 m²/g.

6. The ultrafiltration membrane according to claim 1, wherein the activated carbon is obtained by a process including:
dry-comminuting waste cellulose acetate fibers;
subjecting the comminuted cellulose acetate to hydrothermal carbonization at a temperature of from about 150 to about 350 degrees Celsius (° C.);
drying the carbonized product;
activating the dried carbonized product by heating the product under an inert atmosphere with a solid-state alkali including potassium hydroxide, potassium carbonate or mixtures thereof, and,
cooling and neutralizing the activated product.

7. The ultrafiltration membrane according to claim 6, wherein at least a fraction of the waste cellulose acetate fibers is obtained from used cigarette filters.

8. The ultrafiltration membrane according to claim 1, wherein the hydrophilic polymer binder comprises particles of polyvinylpyrrolidone (PVP).

9. The ultrafiltration membrane according to claim 1 having a flux of at least about 500 lumens per square meter per hour (Lm⁻²h⁻¹), as determined at about 200 kilopascals (kPa) and about 25° C. in accordance with ASTM D5090-20.

10. The ultrafiltration membrane according to claim 9 having a flux of from about 600 to about 800 Lm⁻²h⁻¹, as determined at about 200 kPa and about 25° C. in accordance with ASTM D5090-20.

11. A method of preparing the ultrafiltration membrane according to claim 1, the method including:
admixing particulate kaolin, the fly ash, the activated carbon and the hydrophilic polymer binder;
compression molding the admixture;
isothermally heating the compression molded admixture at a temperature in the range of from about 500 to about 1000° C. for a duration of from about 1 to about 5 hours; and,
cooling the obtained product.

12. The method according to claim 11, wherein the compression molded admixture is isothermally heated at a temperature in the range of from about 800 to about 1000° C. for a duration of from about 2 to about 5 hours (h).

13. The method according to claim 11, wherein the admixed activated carbon is obtained by a process including:
dry-comminuting waste cellulose acetate fibers;
subjecting the comminuted cellulose acetate to hydrothermal carbonization at a temperature of from about 150 to about 350° C.;
drying the carbonized product;
activating the dried carbonized product by heating the product under an inert atmosphere with a solid-state alkali including potassium hydroxide, potassium carbonate or mixtures thereof, and,
cooling and neutralizing the activated product.

14. The ultrafiltration membrane according to claim 13, wherein at least a fraction of the waste cellulose acetate fibers is obtained from used cigarette filters.

15. The method according to claim 13, wherein the hydrothermal carbonization includes:
admixing the comminuted cellulose acetate with water at a ratio by weight of cellulose acetate:water of from about 1:5 to about 1:20; and,
heating the obtained mixture in a closed vessel at a temperature of from about 150 to about 350° C. for a duration of from about 1 to about 5 h.

16. The method according to claim 15, wherein the obtained mixture is heated in a closed vessel at a temperature of from about 150 to about 250° C. for a duration of from about 2 to about 5 h.

17. The method according to claim 13, wherein activating the dried carbonized product includes:
admixing the dried carbonized product with the solid-state alkali; and,
isothermally heating the obtained admixture at a temperature in the range of from about 600 to about 900° C. for a duration of from about 1 to about 3 h.

18. The method according to claim 17, wherein the dried carbonized product and the solid-state alkali are admixed at a ratio by weight of from about 1:2 to about 1:5.

19. The method according to claim 13, wherein the activated product is neutralized by rinsing the product with an aqueous hydrochloride (HCl) solution and subsequently with deionized water.

20. An ultrafiltration method including:
flowing an aqueous dispersion through the ultrafiltration membrane as defined in claim 1; and,
collecting the permeate.
